(19) United States
(12) Patent Application Publication
(10) Pub. No.: US 2026/0221739 A1
(43) Pub. Date: Jul. 30, 2026

(54) Cable Retention System and Method

(71) Applicant: Aptiv Technologies AG, Schaffhausen (CH)

(72) Inventors: David R. Peterson, Aurora, OH (US); Jeffrey Michael, Austintown, OH (US); Stephen VanSuch, Streetsboro, OH (US); Robert Dean, New Castle, PA (US); Joseph Sudik, Jr., Niles, OH (US)

(21) Appl. No.: 19/038,749

(22) Filed: Jan. 28, 2025

(51) Int. Cl. H02G 3/04; B60R 16/02; H01B 7/00

(52) U.S. Cl. CPC H02G 3/045; B60R 16/0215; H01B 7/0045

(57) ABSTRACT

A flexible substrate includes a first edge, a second edge, a first side, a second side, a first aperture, and a first ratchet tab. The second edge is opposite the first edge. The first side extends from the first edge to the second edge. The second side is opposite the first side and extends from the first edge to the second edge. The first aperture is formed through the first side and the second side between the first edge and the second edge. The first aperture is configured to receive a first cable tie. The first ratchet tab is disposed within the first aperture and is configured to engage the first cable tie.

### FIELD

The present disclosure relates to a system and method for retaining a cable and more particularly to a system and method for retaining a cable within a channel.

### BACKGROUND

Modern vehicles (e.g., automobiles) rely on electrical wiring and electrical connections to facilitate the transmission of electricity within, and between various components of, the vehicle. Wiring harnesses (e.g., connectors and bundles of wires/cables) play an important role in ensuring the integrity of these electrical connections and the reliability and performance of the vehicle. Wiring harnesses and cables often lack the structural integrity (e.g., rigidity) to ensure the accurate and repeatable handling, positioning, and securement of the wiring harnesses and/or other components during an assembly process. Often, these cables are secured to another component to provide the necessary rigidity. Current methods of securing wiring harnesses and cables require high levels of manual labor and may not secure the wiring harnesses or cables to the component as effectively as desired. In view of the foregoing, while known systems and methods for routing and retaining wiring harnesses and cables may be acceptable for their intended purposes, there exists a continuous need in the pertinent art for improvement.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

One aspect of the disclosure provides a flexible substrate. The flexible substrate includes a first edge, a second edge, a first side, a second side, a first aperture, and a first ratchet tab. The second edge is opposite the first edge. The first side extends from the first edge to the second edge. The second side is opposite the first side and extends from the first edge to the second edge. The first aperture is formed through the first side and the second side between the first edge and the second edge. The first aperture is configured to receive a first cable tie. The first ratchet tab is disposed within the first aperture and is configured to engage the first cable tie.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The present disclosure will become more fully understood from the detailed description and the accompanying drawings.

FIG. 1A is a perspective view of a cable retention system in accordance with the principles of the present disclosure.

FIG. 1B is a front view of the cable retention system of FIG. 1A.

FIG. 2A is a first perspective view of a slot of a cable retention system in accordance with the principles of the present disclosure.

FIG. 2B is a second perspective view of the slot of the cable retention system of FIG. 2A.

FIG. 3 is a cross-sectional view of an aperture of a cable retention system in accordance with the principles of the present disclosure.

In the drawings, reference numbers may be reused to identify similar and/or identical elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

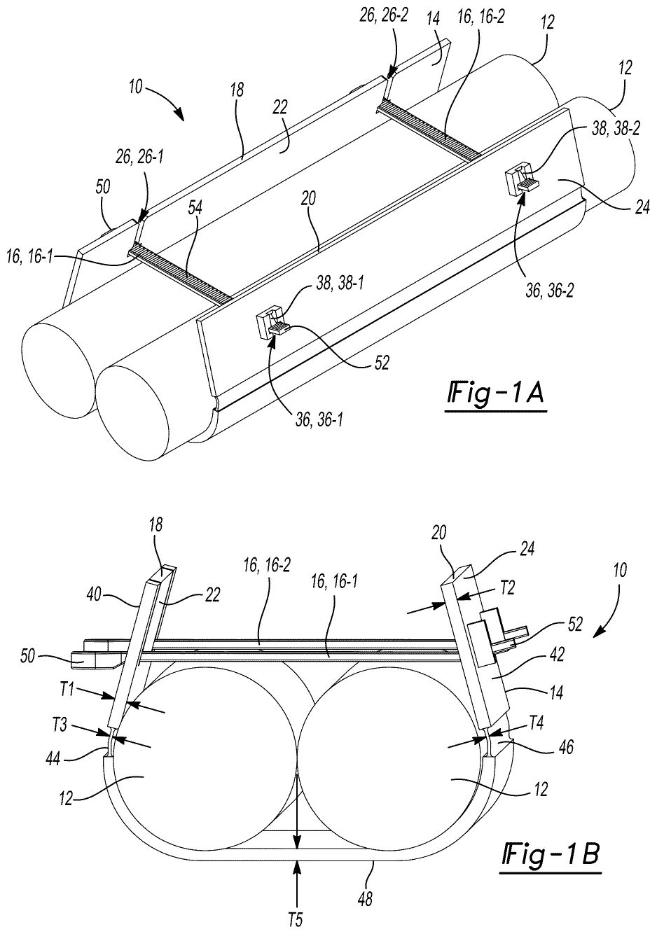

With reference to FIGS. 1A and 1B, a cable retention system 10 is illustrated. As will be explained in more detail below, the cable retention system 10 may be used during installation of one or more cables 12 (e.g., as part of a wiring harness) to route and secure the one or more cables 12 in place. In particular, the cable retention system 10 may be used during installation of one or more cables 12 in a vehicle (not shown), such as an automobile.

The cable retention system 10 may include a substrate 14 and one or more cable ties 16. For example, the one or more cable ties may include a first cable tie 16-1 and a second cable tie 16-2. In some implementations, the one or more cables 12 are at least partially surrounded by the substrate 14 and/or the one or more cable ties 16. In an assembled configuration (FIGS. 1A and 1B), the one or more cable ties 16 may be coupled to the substrate 14 to secure the one or more cables 12 during a method of installing the one or more cables 12.

The substrate 14 may include a first edge 18, a second edge 20, a first side 22, and a second side 24. The second edge 20 may be opposite the first edge 18. The first side 22 may extend between the first edge 18 and the second edge 20. The second side 24 may be opposite the fist side 22 and may extend between the first edge 18 and the second edge 20. In some implementations, the substrate 14 is formed of a flexible material, such that the substrate 14 may flex (e.g., bend) in one or more directions. In this regard, the substrate 14 may be referred to herein as the flexible substrate 14. Prior to being wrapped around the one or more cables 12 and being secured by the one or more cable ties 16, the substrate 14 may define a substantially flat sheet. In the assembled configuration (FIGS. 1A and 1B), the substrate 14 may be wrapped, at least partially, around the one or more cables 12 and secured in place by the one or more cable ties 16.

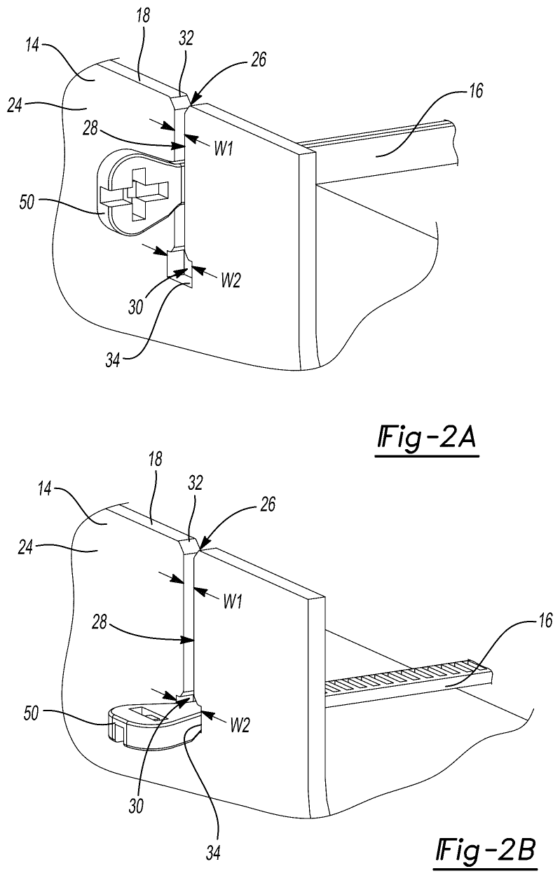

With reference to FIGS. 2A and 2B, the substrate 14 may include one or more slots 26. For example, the substrate 14 may include a first slot 26-1 and a second slot 26-2. Each of the one or more slots 26 may be formed in the first edge 18 and extend through the first side 22 and the second side 24. In the assembled configuration, each of the one or more slots 26 may receive a corresponding cable tie 16. For example, the first slot 26-1 may receive the first cable tie 16-1 and the second slot 26-2 may receive the second cable tie 16-2.

In some implementations, each of the one or more slots 26 includes a first portion 28 and a second portion 30. The first portion 28 may define a first width W1. The second portion 30 may be disposed below the first portion 28 and may define a second width W2. In some implementations, the second width W2 is greater than the first width W1. In some implementations, each slot 26 includes a first end 32 formed in the first edge 18 and a second end 34 opposite the first end 32. The first portion 28 may be formed between the first end 32 and the second end 34. The second portion 30 may also be formed between the first end 32 and the second end 34.

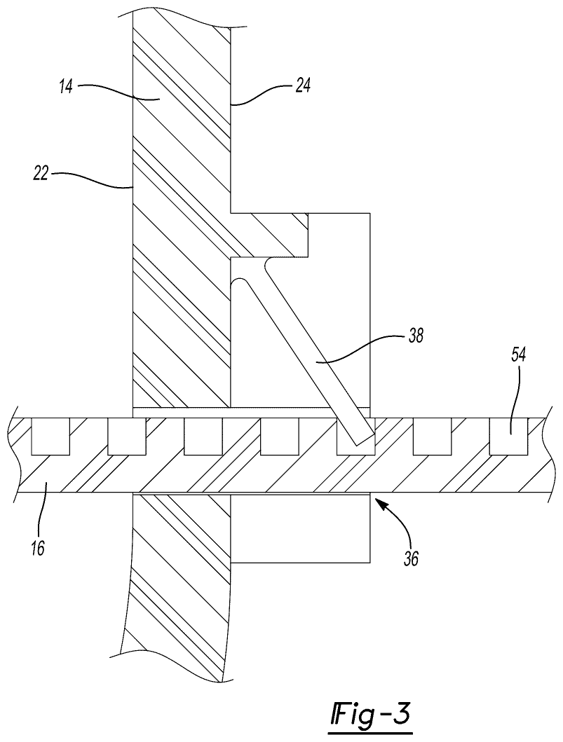

With reference to FIGS. 1A and 3, the substrate 14 may include one or more apertures 36 and one or more ratchet tabs 38. Each of the one or more ratchet tabs 38 may be disposed in a corresponding aperture 36 of the one or more apertures 36. For example, the substrate 14 may include a first ratchet tab 38-1 disposed in a first aperture 36-1 and a second ratchet tab 38-2 disposed in a second aperture 36-2.

Each of the one or more apertures 36 may be formed through the first side 22 and the second side 24 of the substrate 14. Each of the one or more apertures 36 may be disposed between the one or more slots 26 and the second edge 20. In the assembled configuration (FIGS. 1A and 1B), each of the one or more apertures 36 may receive a corresponding cable tie 16. For example, the first aperture 36-1 may receive the first cable tie 16-1 and the second aperture 36-2 may receive the second cable tie 16-2.

Each of the one or more ratchet tabs 38 may be integrally formed with the substrate 14 (e.g., the second side 24). In some implementations, when the cable tie 16 is disposed in the aperture 36, the ratchet tab 38 may engage the cable tie 16, such that the ratchet tab 38 prevents movement of the cable tie 16 relative to the substrate 14. In this regard, engagement of the one or more ratchet tabs 38 with the one or more cable ties 16 may ensure that the substrate 14 remains wrapped around the one or more cables 12 in the assembled configuration (FIGS. 1A and 1B).

Referring back to FIGS. 1A and 1B, in some implementations, the substrate 14 includes a first portion 40, a second portion 42, and a first hinge portion 44. The first portion 40 may extend from the first edge 18 and may define a first thickness T1 extending between the first side 22 and the second side 24. The second portion 42 may extend from the second edge 20 and may define a second thickness T2 extending between the first side 22 and the second side 24. The first hinge portion 44 may be disposed between the first portion 40 and the second portion 42 and may allow the first portion 40 to flex (e.g., bend) relative to the second portion 42. The first hinge portion 44 may define a third thickness T3 extending between the first side 22 and the second side 24. The third thickness T3 may be less than the first thickness T1. The third thickness T3 may be less than the second thickness T2. The first thickness T1 may be substantially equal to the second thickness T2.

In some implementations, the one or more slots 26 (e.g., the first slot 26-1 and/or the second slot 26-2) are formed in the first portion 40. In some implementations, the one or more apertures 36 (e.g., the first aperture 36-1 and/or the second aperture 36-2) are formed in the second portion 42.

In some implementations, the substrate 14 includes a second hinge portion 46 disposed between the first hinge portion 44 and the second portion 42 that allows the first portion 40 to flex (e.g., bend) relative to the second portion 42. The second hinge portion 46 may define a fourth thickness T4 extending between the first side 22 and the second side 24. The fourth thickness T4 may be less than the first thickness T1. The fourth thickness T4 may be less than the second thickness T2. The fourth thickness T4 may be substantially equal to the third thickness T3.

In some implementations, the substrate 14 includes a third portion 48 disposed between the first hinge portion 44 and the second hinge portion 46. The third portion 48 may define a fifth thickness T5 extending between the first side 22 and the second side 24. The fifth thickness T5 may be greater than the third thickness T3 and/or the fourth thickness T4. The fifth thickness T5 may be substantially equal to the first thickness T1 and/or the second thickness T2.

Each of the one or more cable ties 16 may include a first end 50, a second end 52 opposite the first end 50, and a set of recesses 54 disposed between the first end 50 and the second end 52. The cable ties 16 may be any previously known and/or existing cable ties 16.

A method of using a cable retention system (e.g., the cable retention system 10) will be described in more detail below, with reference to FIGS. 1A-3. To start, the substrate 14 may be placed beneath the one or more cables 12. The substrate 14 may be wrapped around the one or more cables 12. For example, the first portion 40 and/or the second portion 42 of the substrate 14 may be flexed (e.g., bent) around the one or more cables 12 in one or more directions.

The first end 50 of the first cable tie 16-1 may be inserted into the first slot 26-1 (e.g., the first portion 28) in a first (e.g., vertical) orientation (FIG. 2A). The first cable 16-1 may be inserted into the second portion 30 of the first slot 26-1 and rotated into a second (e.g., horizontal) orientation (FIG. 2B). The size, shape, and/or orientation of the first cable tie 16-1 (e.g., the first end 50) may allow the first cable tie 16-1 to be securely held in place by the first slot 26-1.

The second end 52 of the first cable tie 16-1 may be inserted into the first aperture 36-1. When the second end 52 of the first cable tie 16-1 is inserted into the first aperture 36-1, the first ratchet tab 38-1 engages one of the set of recesses 54. The first cable tie 16-1 may be pulled through the first aperture 36-1, such that the first ratchet tab 38-1 engages another one of the set of recesses 54. This movement (e.g., tightening) of the first cable tie 16-1 may flex (e.g., bend) the second portion 42 of the substrate 14 towards the first portion 40 of the substrate 14 to more securely hold the one or more cables 12 within the substrate 14. In some implementations, the portion of the first cable tie 16-1 extending through the first aperture 36-1 beyond the second side 24 of the substrate 14 may be cut off.

In some implementations, the second cable tie 16-2 is inserted into the second slot 26-2 and/or the second aperture 36-2 in the same or a similar manner as the first cable tie 16-1. Together, the first and second cable ties 16-1, 16-2 and the substrate 14 may secure the one or more cables 12.

Various example embodiments of the invention are described in the following clauses.

Clause 1: A flexible substrate comprising: a first edge; a second edge opposite the first edge; a first side extending from the first edge to the second edge; a second side opposite the first side and extending from the first edge to the second edge; a first aperture formed through the first side and the second side between the first edge and the second edge, the first aperture configured to receive a first cable tie; and a first ratchet tab disposed within the first aperture and configured to engage the first cable tie.

Clause 2: The flexible substrate of clause 1, further comprising a first slot formed in the first edge and extending through the first side and the second side, the first slot configured to receive the first cable tie.

Clause 3: The flexible substrate of clause 2, wherein the first slot includes: a first portion defining a first width, and a second portion defining a second width greater than the first width.

Clause 4: The flexible substrate of clause 3, wherein: the first slot includes a first end formed in the first edge, and a second end opposite the first end; the first portion is formed between the first end and the second end; and the second portion is formed between the first portion and the second end.

Clause 5: The flexible substrate of any of clauses 1 through 4, further comprising: a second slot formed in the first edge and extending through the first side and the second side, the second slot configured to receive a second cable tie; a second aperture formed through the first side and the second side between the second slot and the second edge, the second aperture configured to receive the second cable tie; and a second ratchet tab disposed within the second aperture and configured to engage the second cable tie.

Clause 6: The flexible substrate of any of clauses 1 through 5, further comprising: a first portion extending from the first edge and defining a first thickness extending between the first side and the second side; a second portion extending from the second edge and defining a second thickness extending between the first side and the second side; and a first hinge portion disposed between the first portion and the second portion and defining a third thickness extending between the first side and the second side.

Clause 7: The flexible substrate of clause 6, wherein the third thickness is less than the first thickness.

Clause 8: The flexible substrate of clauses 6 or 7, wherein the third thickness is less than the second thickness.

Clause 9: The flexible substrate of clause 8, wherein the third thickness is less than the first thickness.

Clause 10: The flexible substrate of any of clauses 6 through 9, wherein the first hinge portion is configured to allow the first portion to flex relative to the second portion.

Clause 11: The flexible substrate of any of clauses 6 through 10, further comprising a first slot formed in the first portion and extending through the first side and the second side, the first slot configured to receive a first cable tie

Clause 12: The flexible substrate of any of clauses 6 through 11, wherein the first aperture is formed in the second portion.

Clause 13: The flexible substrate of any of clauses 6 through 12, further comprising a second hinge portion disposed between the first hinge portion and the second portion and defining a fourth thickness extending between the first side and the second side.

Clause 14: The flexible substrate of clause 13, wherein the fourth thickness is less than the first thickness.

Clause 15: The flexible substrate of clauses 13 or 14, wherein the fourth thickness is less than the second thickness.

Clause 16: The flexible substrate of clause 15, wherein the fourth thickness is less than the first thickness.

Clause 17: The flexible substrate of any of clauses 13 through 16, wherein the second hinge portion is configured to allow the second portion to rotate relative to the first portion.

Clause 18: The flexible substrate of any of clauses 13 through 17, further comprising a third portion disposed between the first hinge portion and the second hinge portion and defining a fifth thickness extending between the first side and the second side.

Clause 19: The flexible substrate of clause 18, wherein the fifth thickness is greater than the third thickness and the fourth thickness.

Clause 20: The flexible substrate of clauses 18 or 19, wherein the fifth thickness is substantially equal to the first thickness.

Clause 21: The flexible substrate of any of clauses 18 through 20, wherein the fifth thickness is substantially equal to the second thickness.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A flexible substrate comprising:
a first edge;
a second edge opposite the first edge;
a first side extending from the first edge to the second edge;
a second side opposite the first side and extending from the first edge to the second edge;
a first aperture formed through the first side and the second side between the first edge and the second edge, the first aperture configured to receive a first cable tie; and
a first ratchet tab disposed within the first aperture and configured to engage the first cable tie.

2. The flexible substrate of claim 1, further comprising a first slot formed in the first edge and extending through the first side and the second side, the first slot configured to receive the first cable tie.

3. The flexible substrate of claim 2, wherein the first slot includes:
a first portion defining a first width, and
a second portion defining a second width greater than the first width.

4. The flexible substrate of claim 2, further comprising:
a second slot formed in the first edge and extending through the first side and the second side, the second slot configured to receive a second cable tie;
a second aperture formed through the first side and the second side between the second slot and the second edge, the second aperture configured to receive the second cable tie; and
a second ratchet tab disposed within the second aperture and configured to engage the second cable tie.

5. The flexible substrate of claim 1, further comprising:
a first portion extending from the first edge and defining a first thickness extending between the first side and the second side;
a second portion extending from the second edge and defining a second thickness extending between the first side and the second side; and
a first hinge portion disposed between the first portion and the second portion and defining a third thickness extending between the first side and the second side.

6. The flexible substrate of claim 5, wherein the third thickness is less than the first thickness.

7. The flexible substrate of claim 5, wherein the third thickness is less than the second thickness.

8. The flexible substrate of claim 7, wherein the third thickness is less than the first thickness.

9. The flexible substrate of claim 5, wherein the first hinge portion is configured to allow the first portion to flex relative to the second portion.

10. The flexible substrate of claim 5, further comprising a first slot formed in the first portion and extending through the first side and the second side, the first slot configured to receive a first cable tie.

11. The flexible substrate of claim 10, wherein the first aperture is formed in the second portion.

12. The flexible substrate of claim 5, further comprising a second hinge portion disposed between the first hinge portion and the second portion and defining a fourth thickness extending between the first side and the second side.

13. The flexible substrate of claim 12, wherein the fourth thickness is less than the first thickness.

14. The flexible substrate of claim 12, wherein the fourth thickness is less than the second thickness.

15. The flexible substrate of claim 14, wherein the fourth thickness is less than the first thickness.

16. The flexible substrate of claim 12, wherein the second hinge portion is configured to allow the second portion to rotate relative to the first portion.

17. The flexible substrate of claim 12, further comprising a third portion disposed between the first hinge portion and the second hinge portion and defining a fifth thickness extending between the first side and the second side.

18. The flexible substrate of claim 17, wherein the fifth thickness is greater than the third thickness and the fourth thickness.

19. The flexible substrate of claim 18, wherein the fifth thickness is substantially equal to the first thickness.

20. The flexible substrate of claim 19, wherein the fifth thickness is substantially equal to the second thickness.
